(19) United States
(12) Patent Application Publication
(10) Pub. No.: US 2006/0168569 A1
(43) Pub. Date: Jul. 27, 2006

(54) Beta parser

(75) Inventors: Vincent C. Smith, Seattle, WA (US); Arthur Jefferson DeVos, Renton, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/043,759

(22) Filed: Jan. 26, 2005

(51) Int. Cl. G06F 9/44

(52) U.S. Cl. 717/124

(57) ABSTRACT

A beta parser retrieves and parses a bug report into an appropriate developer database according to the identified beta program for which the bug report was filed. Bug reports are validated and manipulated in specifically defined ways according to stored procedures associated with the beta program identification. The flexible and scalable nature of the beta parser enables developers to define data and procedures for beta programs such that bug reports for the beta programs are stored, modified, and formatted into an appropriate destination database according to developer expectations. Thus, the beta parser provides a common mechanism for gathering and parsing bug reports that is not tied to a particular application, product or platform.

### TECHNICAL FIELD

The present disclosure generally relates to software development, and more particularly, to managing bug reports in the beta test phase of the software development process.

### BACKGROUND

In software development, the beta test phase is the second phase of testing for a software product. In the beta test phase, software is “pre-released” to an example audience to elicit feedback that can be used to improve the software prior to releasing it for sale to the general public. The example audience of “beta testers” can be organized by site types, classes, etc., and typically represents a cross section of users ranging, for example, from industry professionals, OEMs, and independent software vendors down to individual home users.

Beta testing of software products is needed because it is generally not possible to guarantee that computer programs will be completely free from bugs upon an initial release. Complex computer software programs of significant scope (e.g., operating systems) are particularly likely to contain errors and exhibit unexpected and undesirable behavior. Therefore, in order to develop and maintain useful, high-quality software products while minimizing errors and other problems, software developers need to have informative feedback from users. Collecting and analyzing user information related to the use of software is especially challenging in large-scale projects involving a widely-dispersed user base. The beta release test phase is an important step in the software development process where collecting and analyzing user information is particularly useful toward improving software prior to releasing it for sale to the general public.

In the past, utilities have been designed to facilitate the submission of bug reports and other information from users to developers. However, most previous reporting tools and trouble ticket mechanisms have been tied to particular applications, products or platforms. Still other reporting tools have been limited to allowing highly general diagnostic questions to be presented to the user. Changes to and extensions of existing tools have required substantial, time-consuming recoding efforts.

Accordingly, the need exists for a way to improve the collection and management of bug reports and other problem information from users regarding computer software products.

### SUMMARY

A system and methods provide an extensible framework in which a report server facilitates the retrieval and management of information, such as bug reports, regarding a computer software product. A beta parser enables the parsing of external bug reports from an arbitrary number of different software products into a predetermined developer database.

In accordance with one embodiment, the beta parser retrieves a bug report from a network directory. The bug report may be in a compressed file format such as a cabinet (.cab) file. If the bug report is in a compressed file format, the compressed file is decompressed. The bug report is validated based on whether a report XML file matches an associated schema definition file (XSD). The XSD is associated through a beta program identifier (ID) contained in the report XML file. The contents of a valid bug report, including the report XML file, log files, problem reproduction steps, and so on, are stored in SQL tables that have been predefined for the beta program ID. Various procedures that have been predefined according to the beta program ID, are also stored in the SQL tables, and are used to manipulate and modify the contents of the bug report into a form that the program developer expects to see in its developer database. After the beta parser runs all of the stored procedures against the bug report contents, it transfers the modified bug report to a developer's destination database, whose location has been predefined and is also stored in the SQL tables. The beta parser may also perform post-processing procedures defined in the SQL tables, such as sending a confirmation email to the user of the beta program who filed the original bug report.

In another embodiment, prior to storing the contents of a valid bug report into SQL tables predefined for the beta program ID, the beta parser performs a throttling function to determine whether to accept or reject the report. Throttling can be based on user IDs or a limitless variety of field values in the XML report file. For example, for a given user ID or field value pair, a bug report that exceeds a maximum number of bug reports submitted per a given time period, can be rejected.

### BRIEF DESCRIPTION OF THE DRAWINGS

The same reference numerals are used throughout the drawings to reference like components and features.

FIG. 1 illustrates an exemplary environment 100 suitable for parsing external bug reports regarding an arbitrary number of different software products into a predetermined developer database.

FIG. 2 illustrates an exemplary embodiment that shows details of a beta parser configured to retrieve bug reports from a report directory and parse them into a developer destination database.

FIG. 3 illustrates example contents of a .cab file bug report.

FIG. 4 illustrates an example of an SQL table and example contents of the table.

FIG. 5 is a flow diagram illustrating exemplary methods for methods for retrieving bug reports for a variety of beta software platforms and programs and for parsing the bug reports into a developer destination database.

FIG. 6 illustrates an exemplary computing environment suitable for implementing each of the client computers, report directories, report server, and destination databases as shown in FIG. 1.

### DETAILED DESCRIPTION

Introduction

following discussion is directed to a system and methods that enable the common management of problem reports filed on a variety of different programs and platforms. A beta parser retrieves and parses a bug report into an appropriate developer database according to the identified beta program for which the bug report was filed. Bug reports are validated and manipulated in specifically defined ways according to stored procedures associated with the beta program identification.

Advantages of the described system and methods include a flexible and scalable framework that enables developers to define data and procedures for beta programs such that bug reports for the beta programs are stored, modified, and formatted into an appropriate destination database according to developer expectations. Thus, the framework provides a common mechanism for gathering and parsing bug reports that is not tied to a particular application, product or platform.

While this description refers to illustrative embodiments that provide for the retrieval and parsing of bug reports or problem reports, it will be recognized that the disclosed system and methods also apply more broadly to communication between software users and software developers in general, including the submission of other kinds of user information besides bug reports. For example, alternative embodiments may provide support to a user of a software product where the user has not experienced a bug, but rather, seeks assistance in the use of the product.

Exemplary Environment

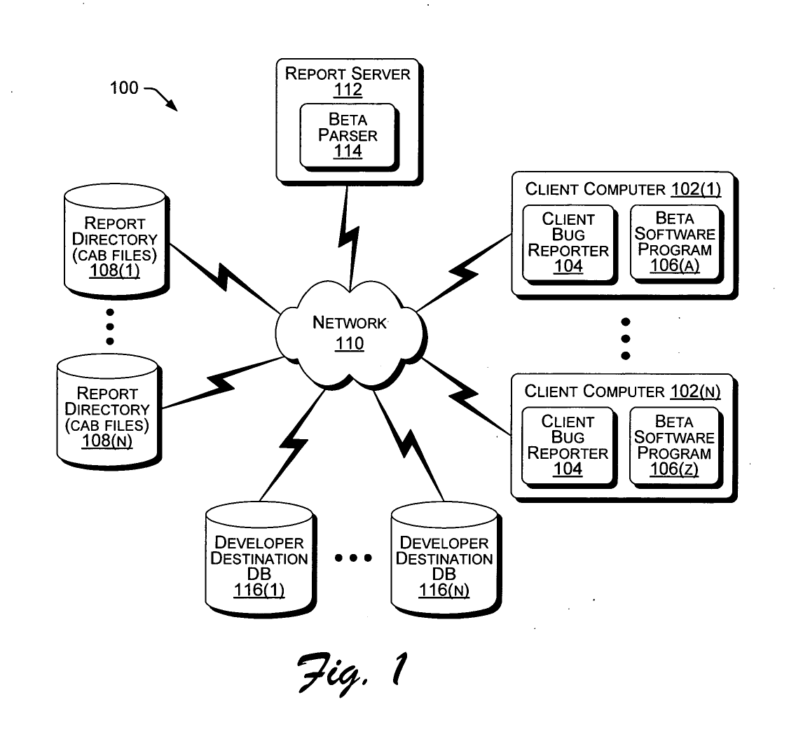

FIG. 1 illustrates an exemplary environment 100 suitable for parsing external bug reports regarding an arbitrary number of different software products into a predetermined developer database. In general, parsing includes tasks such as accessing information and/or files in a bug report, identifying the beta software program on which the bug report is based, processing the bug report to generate a modified bug report that satisfies a software developer's expectation, and storing the modified bug report in a predefined destination database that provides the developer with an appropriate view of the modified bug report.

The exemplary environment 100 includes one or more client computers 102(1)-102(N). Stored on each client computer 102 is an executable client bug reporter 104 and a software program/product 106. The client bug reporter 104 is provided to the user of client computer 102 by, for example, the developer of the software program 106 or by a third-party software provider. The user is, for example, a customer selected by the developers of software program 106 to participate in beta-release testing of the program 106.

Throughout this disclosure, the terms beta software product 106 and beta software program 106, and variations thereof, are generally used interchangeably to refer to a beta-release software product/computer program that resides on a client computer 102 and which is the subject of a bug report that has been generated and stored in a report directory by a client bug reporter 104. A bug report can include, for example, bug report information, a bug report file, and a compressed bug report file such as a cabinet (.cab) file containing a bug report and other related files (e.g., an XML report file, supporting log files, hardware information, reproduction steps for reproducing the problem experienced by the user, etc.). Furthermore, it is noted that, although software programs 106(A)-106(Z) are labeled differently on client computers 102(1)-102(N), this is not intended to indicate that software programs on each client computer are necessarily different programs. In fact, in certain circumstances it is likely that many of client computers 102(1)-102(N) may have the same software program at a given time, as software programs undergoing beta-release testing are generally disseminated amongst test participants at the same time. However, in certain other circumstances, various different software programs may be undergoing beta-release testing at the same time on any number of client computers 102(1)-102(N), and that therefore, the software programs 106 on certain of the client computers 102(1)-102(N) may be different from one another.

If the user of client computer 102 experiences a bug or other problem or issue with respect to the use of beta software program 106, the user runs the client bug reporter 104 in order to generate a bug report and transfer the bug report to a network report directory 108 via network 110. The client bug reporter 104 generates a bug report package that is typically in the form of a cabinet (.cab) file. The .cab file report is a compressed file that includes an Extensible Markup Language (XML) report file and other files and data, such as supporting log files, hardware information and reproduction steps for reproducing the problem experienced by the user. The user can then upload the completed or partially completed report package/.cab file to a network directory 108 via network 110 for future access by report server 112.

The beta parser component 114 of report server 112 is configured to periodically scan report directories 108 for .cab report files. Beta parser 114 retrieves cab report files from report directories 108 that represent bug reports filed by any number of client customers regarding one or more of a variety of different beta programs 106. As discussed more fully below, the beta parser decompresses each cab file to access files from each bug report, identifies the beta software program 106 on which each bug report is based, processes each bug report to generate a modified bug report that meets the software developer's predefined expectations, and transfers the modified bug report into a predefined destination database 116 for the appropriate developer. The developer of the beta software program 106 for which the report was completed can then access or retrieve the modified bug report information through the predefined destination database 116. An example of a destination database 116 is the Product Studio database, available from Microsoft Corporation of Redmond, Wash.

Each of the client computers 102, report directories 108, report server 112, and destination databases 116 are computing devices, or components of a computing device. Such computing devices may be implemented as any of a variety of conventional computing devices, including, for example, a desktop PC, a notebook or portable computer, a workstation, a mainframe computer, an Internet appliance, combinations thereof, and so on. An exemplary computing environment for implementing such devices is described in more detail herein below with reference to FIG. 6.

Typically, the components of exemplary environment 100 (i.e., client computers 102, report directories 108, report server 112, and developer destination databases 116) are remote from one another, and communication between them occurs by way of the network 110. However, in other embodiments, one or more of these components may be located on the same device or at the same location. Network 110 is intended to represent any of a variety of conventional network topologies and types (including optical, wired and/or wireless networks), employing any of a variety of conventional network protocols (including public and/or proprietary protocols). Network 110 may include, for example, a home network, a corporate network, or the Internet, as well as possibly at least portions of one or more local area networks (LANs) and/or wide area networks (WANs).

### Exemplary Embodiments

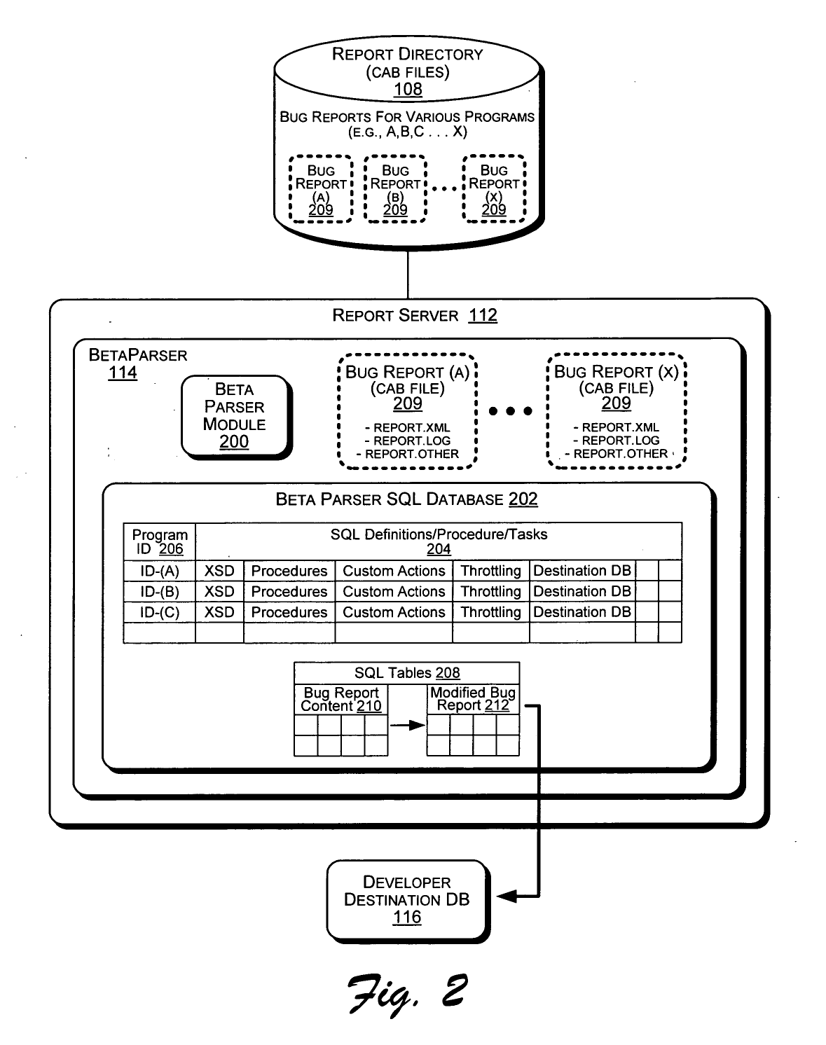

FIG. 2 illustrates an exemplary embodiment that further details a beta parser 114 configured to retrieve bug reports from a report directory 108 and parse them into a developer destination database 116. Beta parser 114 provides a flexible and scalable framework that facilitates a common bug report parsing process to manage bug reports for a variety of software platforms and programs.

As shown in FIG. 2, the beta parser component 114 of report server 112 includes an executable beta parser module 200 and a beta parser SQL database 202. The beta parser SQL database 202 is a single database where definition data and procedures 204 are stored for various beta software programs 106. In the FIG. 2 illustration, the example beta software programs 106 are identified as programs “A”, “B”, “C” . . . “X”. The definitions and procedures 204 attributed to these software programs 106 are stored and made accessible within the SQL database 202 based on beta program IDs 206, which in this example are beta program IDs “A”, “B”, “C” . . . “X”. As discussed further below, the beta parser SQL database 202 includes SQL tables 208 that are predefined according to the beta program IDs 206 (i.e., “A”, “B”, “C” . . . “X”). Bug report content/data 210 is stored in SQL tables 208 according to the beta program IDs 206. The bug report data/contents 210 stored in SQL tables 208 is modified in the beta parser SQL database 202 in accordance with stored procedures 204. The modified bug report 212 is then transferred to a developer destination database 116. The beta parser module 200 is generally configured to manage this process of parsing bug reports by performing various tasks such as retrieving cab file bug reports 209, inserting the bug report contents 210 into the SQL database 202 tables 208, running stored procedures 204 in the SQL database 202 against the bug report contents 210 to generate a modified bug report 212, and transferring the modified report into a destination database 116 predefined by a developer in the definitions 204.

Together, the beta parser module 200 and beta parser SQL database 202 work in conjunction to perform the various beta parsing tasks. An initial task for the beta parser module 200 is retrieving bug reports 209 from one or multiple report directories 108. As shown in FIG. 2, the bug reports 209 may be based on a variety of different software products 106 (e.g., product A, B, . . . X, etc.). Also as noted above, bug reports 209 generated by client bug reporters 104 and retrieved from network report directories 108, are in .cab file form. In an alternate embodiment, however, there is also a web-based problem reporting client (not shown) that generates only a problem report XML file, and places it into the report directories 108.

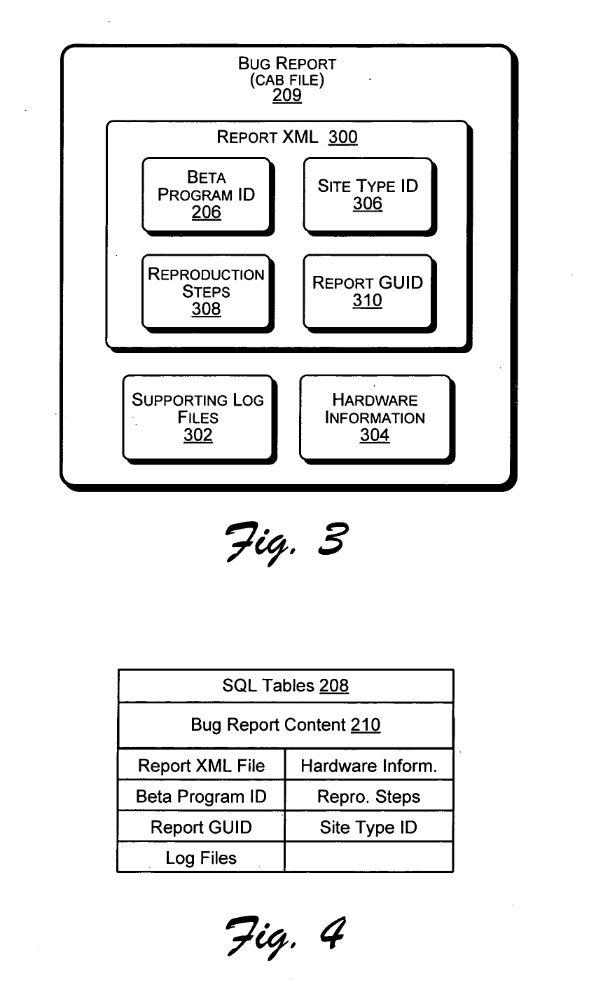

The parser module 200 monitors the report directories 108 and runs as a scheduled task to scan the network report directories 108 and retrieve .cab file bug reports 209 (and/or report XML files) that have been stored there by various client bug reporters 104. Upon retrieving a .cab file bug report 209, the parser module 200 decompresses or opens the .cab file to access its contents. As illustrated in FIG. 3, the contents of a .cab file bug report 209 include a problem report XML file 300 and other files and data, such as supporting log files 302 and hardware information 304. Other files and information may also be provided by a user in the cab file report 209, such as a screen shot graphics file that helps a developer better see and understand the problem that the user is reporting.

After accessing the report XML file 300 (e.g., from decompressing a .cab file bug report, or directly from a network report directory 108), the beta parser module 200 validates the bug report data in order to identify the beta product/program 106 that the bug report 209 was filed on, and to ensure that the data includes the appropriate information in the appropriate and expected form. For each beta program 106, there is a particular problem report XML file 300 that has been defined for submission by a client reporter 104 in a bug report package (i.e., .cab file). In general, a problem report XML file 300 contains the problem report generated by the client bug reporter 104. However, problem report XML files 300 for different beta programs 106 may be formatted differently and contain different information based on a developer-provided schema definition file (XSD). Although problem report XML files 300 may differ between different beta programs 106, each problem report XML file 300 includes the beta program ID 206 discussed above, a site type ID 306, reproduction steps 308 for reproducing the problem experienced by the user, and a globally unique report identifier (GUID) 310 (see FIG. 3) that uniquely identifies the bug report 209. The site type ID 306 identifies a grouping or class of beta customers who may have different priority or tasks associated with them. The site type permits grouping by priority of customer, modifying data fields based on customer, and modifying the developer destination database 116 for report based on customer.

In order to validate the bug report data, the beta parser module 200 first accesses the beta program ID 206 from the report XML file 300. Using the beta program ID 206, the parser module 200 finds the appropriate XSD in the SQL definitions 204 of SQL database 202 to check against the report XML file 300. The parser module 200 compares the report XML file 300 with the XSD for the appropriate beta program 106, as identified by the beta program ID 206, in order to assure validity. If the report XML file 300 and the associated XSD do not match, the bug report (.cab file bug report 209, or single report XML file, depending on how it was submitted) is not processed. An error is logged and the .cab file bug report 209 is moved to a bad reports repository in the SQL database 202. If the schema in the report XML file 300 does match the XSD definition file 204 for the given beta program 106, then the beta parser 114 continues processing the bug report 209.

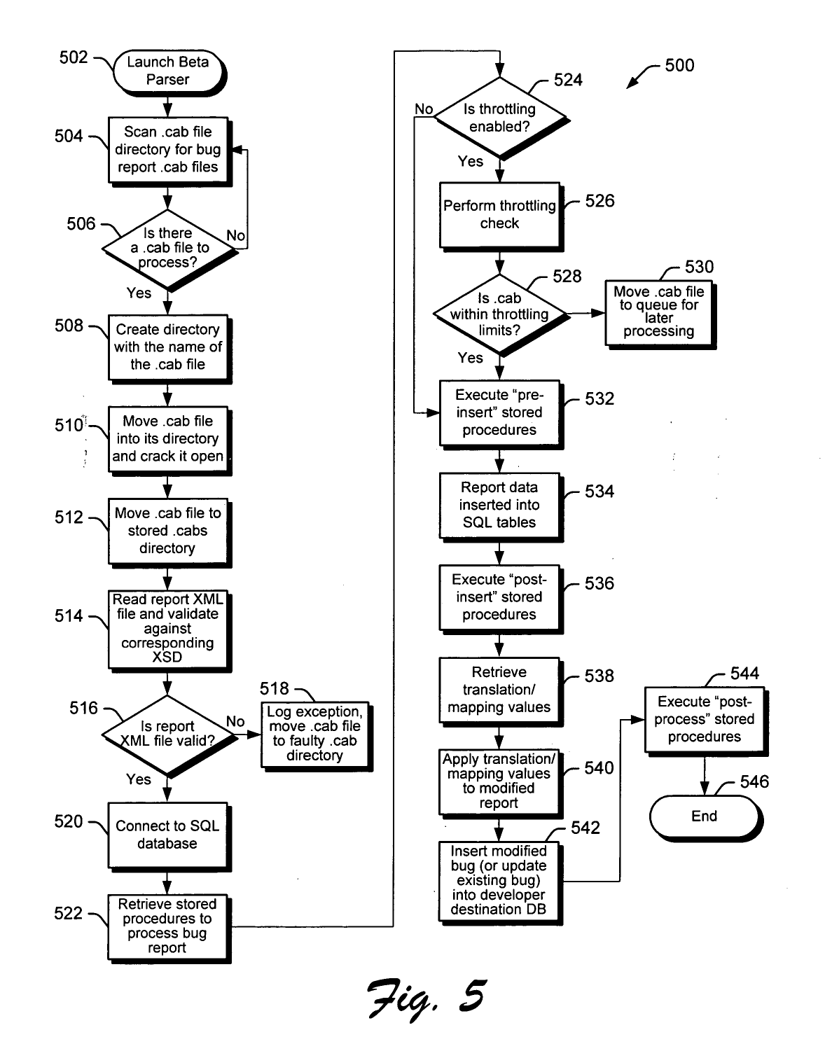

After the beta parser module 200 validates the data in the bug report 209, it places the original bug report contents 210 into the SQL tables 208 as shown in FIG. 2. Therefore, as shown in FIG. 4, the SQL tables 208 can include, for example, the report XML file 300, the beta program ID 206, the site type ID 306, the bug report GUID 310, supporting log files 302, hardware information 304, reproduction steps 308, and so on. The SQL tables 208 are created for each beta program 106 where the original report data will be stored. The table containing the original bug report content 210 will not be updated.

In one embodiment, prior to storing the original bug report contents 210 into the SQL tables 208, the beta parser module 200 performs a throttling function to determine whether to accept or reject bug reports 209 based on whether a maximum number of bug reports per period of time have been filed for a particular user identification, beta program ID 206, site type ID 306, and/or field value pairing. The throttling and rejection of bug reports 209 can be based on a limitless variety of field values. The general purpose of the throttling is to limit the number of bug reports 209 that a given testing site or client computer 102 (based on a beta program ID 206) may submit, for example, per day. In addition, throttling can be used to reject bug reports 209 submitted on a beta client bug reporter 104 that is old or has been closed.

In general, throttling is broken up into user ID throttling and field value throttling. For user ID throttling, the beta parser module 200 stores each user ID that is submitted with the bug report 209 in a table. For each bug report 209 the parser module 200 checks in the table, if a duplicate user ID already exists, a column in the table that indicates the number of bug reports 209 the user ID has remaining, is decremented by one. For example, a ‘BugsRemaining’ column would be decremented. If the user ID does not exist in the table, the parser module 200 inserts a new row in the table and sets the ‘BugsRemaining’ column equal to at value stored in a column indicating the maximum allowed bug reports 209, such as a ‘MaxBugs’ column. If the ‘BugsRemaining’ column ever reaches zero in a 24 hour period (or some other predetermined period), the parser module 200 will reject all bug reports 209 filed by that user ID and log errors as described in more detail herein below. At the end of the 24 hour period, the ‘BugsRemaining’ counter is reset.

For field value throttling, the administrator of the beta parser 114 can setup different field (xml element)/value pairs for a specific beta program 106 and set a maximum number of bug reports 209 that have a matching field/value pair. If the ‘BugsRemaining’ column ever reaches zero within a predetermined time period, the bug report is rejected and the beta parser module 200 logs an error. This is useful for rejecting bug reports based on an outdated client bug reporter 104 or a beta program long closed.

Once a bug report 209 is retrieved, validated, accepted beyond the throttling process, and its original contents 210 stored in SQL tables 208, the beta parser module 200 runs any stored procedures 204 (tasks, custom actions, etc.) from the SQL database 202 against the contents 210 stored in the SQL tables 208. There are three stages throughout the parsing process where tasks can be run. The first stage is a ‘pre-insert’ stage, where tasks can be run after throttling but before the bug report data/content 210 is inserted into the SQL table 208 defined for its beta program ID 206. The next stage is a ‘post-insert’ stage, where tasks can be run after the bug report data/content 210 is inserted into the SQL table 208 but before the data/content 210 is queried for by the beta parser module 200 to insert the modified bug report 212 into the developer's destination database 116. The last stage is a ‘post-process’ stage where tasks are run at the end of the parsing process when the modified bug report identification has been generated by the destination database 116.

Tasks/procedures 204 can be defined for a variety of things, including formatting data, determining the destination database 116, and any cleanup work such as sending confirmation email to the customer who filed the bug report 209. Most data formatting tasks are run in the post-insert phase of the process.

Tasks 204 can be defined as reusable tasks that can be run on a set of bug reports 209 based on the beta program 106 and the destination database 116. Tasks 204 can also be run based on XML element/value pairs and based on a defined order.

The beta parser 114 provides flexibility through SQL tables that store the names of all of the tasks (stored procedures) 204 to be run for each bug report 209 in each beta program 106/destination database 116 combination. There are columns for the XML element name/value pair to match in order for a task to run. There is also a column for ordering tasks by priority. For example, if there is a beta program 106 in which a requirement is to have all bug reports 209 contain a special tag in the title when the language of the report is German, an entry for that condition will be created in the table.

The beta parser 114 parses into a destination database 116 on a per-report basis, based on criteria determined by the owner of the beta program 106. In parsing the bug report data 210, the beta parser module 200 provides translations for mismatched report elements to fields in the destination database 116. The parser module 200 also provides default values for destination database 116 fields based on the beta program 106 and destination database 116, and attaches any files to the destination database 116 bug sent with report.

The beta parser module 200 is configured to accommodate logging an error at any step in the process. When an error is encountered the parser module 200 makes an entry to an SQL error logging table that contains errors, exception information, stack frame, a dump of variables (i.e., a report ID, an email address, etc.), and a mail message ID if applicable. When the beta parser module 200 encounters an error in the parsing process it uses 3 severity levels, FailureAudit, Warning, and Error. For all cases, it logs the error to an SQL table (when possible) and to the event log on the machine the beta parser module 200 is running on. The parser module 200 logs a specific error code value that represents where the exception was thrown in code, a parser error message, the exception's parameters, and any specifics that will help with debugging. When logging the error the beta parser module 200 checks a table for an optional mail message to send to the customer which explains the error. It does this by matching values from the exception with the corresponding columns in the table. It will use the mail message for the most specific error matched. This allows for defining mail messages for an exception class, and other mail messages for specific exceptions of that class.

The beta parser 114 can also provide other features that certain beta programs 106 may require. Such features, such as inserting a beta test site's contact information into the modified bug report 212 that is inserted into the destination database 116, are also provided as stored procedures or tasks 204. When inserting a bug reporting site's contact information, text containing the reporting site's contact information is formatted and later inserted into the description field of the destination database 116. The contact information is looked up from various tables depending on whether the test site is on the technical beta, the non-technical beta, or is an internal test site. If the beta test site has no contact information, placeholder text is used to state that no contact information was provided.

The contact information stored procedure 204 that builds the description field for the destination database 116 uses the report GUID 310 to derive a BetaID and a SiteUser ID associated with the bug report 209. Once this is obtained, a simple test is performed to determine if the site is on the technical beta or not, and the contact information for the site is accessed from the appropriate table. The text containing the site's contact information is then built and formatted. As noted above, if no contact information is available, placeholder text is used to state that no contact information was provided. This text is passed back to the stored procedure 204 that builds of the description field for the destination database 116.

Another feature the beta parser 114 can provide is to transform the beta program 106 build number as it arrives in the bug report 209 and transform it into the build number format expected by the developer's destination database 116. For example, consider that the destination database 116 expects a build number format of nn.nn.nn.nnnn, e.g. “00.00.00.2180”. The parser module 200 calls the build number handling stored procedure 204 during the post-insert point of the parsing process. This build number handling stored procedure 204 then uses a cursor to step through the rows in an SQL table containing possible build number patterns for the initial build number value supplied in the bug report 209. It gets a hit on pattern nnnn.n, and the row with this pattern and target destination database 116 ID contains the name of the stored procedure 204 needed to convert nnnn.n into nn.nn.nn.nnnn. This “conversion” stored procedure 204 is executed, and takes the leftmost four numbers of the initial build number and uses that value to build a new build number in the format the destination database 116 expects. The output contains a value of “00.00.00.2180”. The parser module temporary SQL table is updated with the new value, and when the bug report is parsed, the destination database 116 will receive the beta program 106 build number in the format it expects.

Another feature the beta parser 114 can provide is to optionally send an auto-response confirmation email to the reporting beta site to let them know their bug report was received. The beta parser module 200 can use SMTP with any account as the sender, such as an unmonitored system account, a monitored alias, an internal person, etc. There is an option to have different message text based on the beta program 106, and the type of site and language. An SQL table is created where mail messages are stored along with a mail message ID. This ID is stored in another table along with the Beta Program 106, the Site Type and Language ID. When a bug report that has these matching values is parsed, the corresponding mail message is used to send mail back to the customer.

When the mail messages are defined, special tags are used to represent fields from the bug report for which the mail is being sent. The column name is encased in tags like so [!NAME!]. As an example, if the TITLE column is required for the mail message subject line, [!TITLE!] would be used in the mail message table's “subject” column. When the mail is sent back to the customer, this tag would be replaced by the title from the bug report.

Exemplary Methods

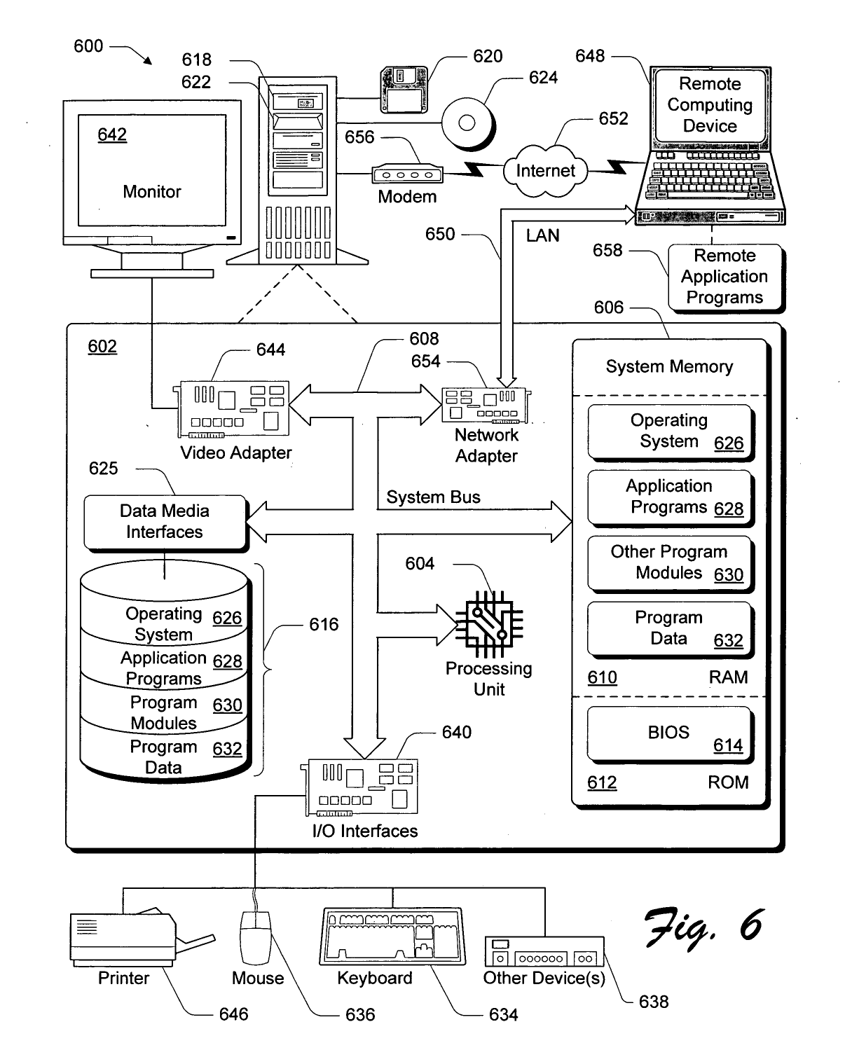

Example methods for retrieving bug reports for a variety of beta software platforms and programs and for parsing the bug reports into a developer destination database 116 based on the identified beta program will now be described with primary reference to the flow diagrams of FIG. 5. The methods apply generally to the exemplary embodiments discussed above with respect to FIGS. 1-4. While one or more methods are disclosed by means of flow diagrams and text associated with the blocks of the flow diagrams, it is to be understood that the elements of the described methods do not necessarily have to be performed in the order in which they are presented, and that alternative orders may result in similar advantages. Furthermore, the methods are not exclusive and can be performed alone or in combination with one another. The elements of the described methods may be performed by any appropriate means including, for example, by hardware logic blocks on an ASIC or by the execution of processor-readable instructions defined on a processor-readable medium.

A “processor-readable medium,” as used herein, can be any means that can contain, store, communicate, propagate, or transport instructions for use or execution by a processor. A processor-readable medium can be, without limitation, an electronic, magnetic, optical, electromagnetic, infrared, or semiconductor system, apparatus, device, or propagation medium. More specific examples of a processor-readable medium include, among others, an electrical connection (electronic) having one or more wires, a portable computer diskette (magnetic), a random access memory (RAM) (magnetic), a read-only memory (ROM) (magnetic), an erasable programmable-read-only memory (EPROM or Flash memory), an optical fiber (optical), a rewritable compact disc (CD-RW) (optical), and a portable compact disc read-only memory (CDROM) (optical).

Method 500 begins at block 502, with the launching of a beta parser 114. The beta parser 114 is typically launched as a scheduled task to scan certain directories such as network report directories 108 and to retrieve bug reports such as .cab file bug reports 209 (and/or report XML files) that have been stored there by various client bug reporters 104. However, the beta parser 114 may also be launched based on other initiating factors including, for example, a notice from a client bug reporter 104 that a bug report has been filed in a particular network report directory 108.

At block 504, the beta parser 114 scans one or more network report directories 108 for bug report .cab files. The beta parser 114 also scans for report XML files that may have been sent to network report directories 108 from a Web-based problem reporting client that generates only problem report XML files, and stores them into the report directories 108. At block 506, the beta parser 114 determines if there are any .cab file bug reports 209 in any of the report directories 108, and if not, it continues to scan them, for example, on a scheduled basis until there are .cab file bug reports available in one or more report directories 108.

After retrieving a .cab file bug report 209 from a report directory 108, the beta parser 114 creates a directory with the name of the cab file bug report, as shown at block 508. At block 510, the beta parser 114 moves the .cab file bug report into the directory and cracks it open. The cab file report is a compressed file that includes an Extensible Markup Language (XML) report file and other files and data, such as supporting log files, hardware information and reproduction steps for reproducing the problem experienced by the user. After decompressing or opening the .cab file to make its files and other data accessible, at block 512 the beta parser 114 moves the cab file bug report to a stored .cab file directory.

At block 514, the beta parser reads the report XML file 300 and validates it against a corresponding schema definition (XSD) based on a beta program ID 206 and a site type ID 306. The corresponding XSD is located in an SQL definitions 204 table of SQL database 202 based on the beta program ID 206 from the report XML file 300. At block 516, the parser module 200 compares the report XML file 300 with the XSD to determine if the report XML file 300 is valid. If the report XML file 300 and the associated XSD do not match, the cab file bug report 209 is not valid so it is not processed. Rather, at block 518, an error is logged and the .cab file bug report is moved to a faulty reports repository in the SQL database 202.

However, if the schema in the report XML file 300 does match the XSD, then the beta parser 114 continues processing the bug report 209. Thus, at block 520, the beta parser 114 connects to the SQL database 202 and retrieves stored procedures to process the bug report (block 522).

At block 524, the beta parser 114 determines if throttling is enabled. Throttling is used to determine whether to accept or reject the cab file bug report 209 based on whether a maximum number of bug reports has been reached or exceeded for the beta software program 106 that is associated with the bug report, and based on a throttling variable. The throttling variable can be, for example, an identification of a user who submitted the bug report or a matching field value from within the bug report. If throttling is not enabled, the beta parser 114 begins executing stored procedures against the bug report at block 532. However, if throttling is enabled, the beta parser 114 performs the throttling check at block 526, and determines whether the .cab file bug report is within the maximum throttling limits (i.e., whether a maximum number of bug reports has been reached or exceeded) at block 528. If the .cab file report is note within the throttling limits, it is moved to a queue for later processing at block 530. If the cab file report is within the throttling limits, however, the beta parser 114 proceeds with executing stored procedures against the bug report at block 532.

At block 534, the contents of the .cab file bug report 209 are inserted into SQL tables 208 according to the beta program ID 206. At block 536, the bug report contents 210 stored in SQL tables 208 are modified in the beta parser SQL database 202 in accordance with post-insert stored procedures. Mapping values for mapping the modified bug report into a destination database 116 are retrieved at block 538 and applied to the modified report at block 540. The beta parser 114 then inserts the modified bug report into the target developer database 116 at block 542. At block 544, post-process stored procedures can be performed, such as sending a confirmation email to the client bug reporter that the bug has been received and processed. The method ends at block 546.

Exemplary Computing Environment

FIG. 6 illustrates an exemplary computing environment suitable for implementing each of the client computers 102, report directories 108, report server 112, and destination databases 116 as discussed above with reference to FIGS. 1-5. Although one specific configuration is shown in FIG. 6, such computing devices may be implemented in other computing configurations.

The computing environment 600 includes a general-purpose computing system in the form of a computer 602. The components of computer 602 may include, but are not limited to, one or more processors or processing units 604, a system memory 606, and a system bus 608 that couples various system components including the processor 604 to the system memory 606.

The system bus 608 represents one or more of any of several types of bus structures, including a memory bus or memory controller, a peripheral bus, an accelerated graphics port, and a processor or local bus using any of a variety of bus architectures. An example of a system bus 608 would be a Peripheral Component Interconnects (PCI) bus, also known as a Mezzanine bus.

Computer 602 includes a variety of computer-readable media. Such media can be any available media that is accessible by computer 602 and includes both volatile and non-volatile media, removable and non-removable media. The system memory 606 includes computer readable media in the form of volatile memory, such as random access memory (RAM) 610, and/or non-volatile memory, such as read only memory (ROM) 612. A basic input/output system (BIOS) 614, containing the basic routines that help to transfer information between elements within computer 602, such as during start-up, is stored in ROM 612. RAM 610 contains data and/or program modules that are immediately accessible to and/or presently operated on by the processing unit 604.

Computer 602 may also include other removable/non-removable, volatile/non-volatile computer storage media. By way of example, FIG. 6 illustrates a hard disk drive 616 for reading from and writing to a non-removable, non-volatile magnetic media (not shown), a magnetic disk drive 618 for reading from and writing to a removable, non-volatile magnetic disk 620 (e.g., a “floppy disk”), and an optical disk drive 622 for reading from and/or writing to a removable, non-volatile optical disk 624 such as a CD-ROM, DVD-ROM, or other optical media. The hard disk drive 616, magnetic disk drive 618, and optical disk drive 622 are each connected to the system bus 608 by one or more data media interfaces 625. Alternatively, the hard disk drive 616, magnetic disk drive 618, and optical disk drive 622 may be connected to the system bus 608 by a SCSI interface (not shown).

The disk drives and their associated computer-readable media provide non-volatile storage of computer readable instructions, data structures, program modules, and other data for computer 602. Although the example illustrates a hard disk 616, a removable magnetic disk 620, and a removable optical disk 624, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 616, magnetic disk 620, optical disk 624, ROM 612, and/or RAM 610, including by way of example, an operating system 626, one or more application programs 628, other program modules 630, and program data 632. Each of such operating system 626, one or more application programs 628, other program modules 630, and program data 632 (or some combination thereof) may include an embodiment of a caching scheme for user network access information.

Computer 602 can include a variety of computer/processor readable media identified as communication media. Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

A user can enter commands and information into computer system 602 via input devices such as a keyboard 634 and a pointing device 636 (e.g., a “mouse”). Other input devices 638 (not shown specifically) may include a microphone, joystick, game pad, satellite dish, serial port, scanner, and/or the like. These and other input devices are connected to the processing unit 604 via input/output interfaces 640 that are coupled to the system bus 608, but may be connected by other interface and bus structures, such as a parallel port, game port, or a universal serial bus (USB).

A monitor 642 or other type of display device may also be connected to the system bus 608 via an interface, such as a video adapter 644. In addition to the monitor 642, other output peripheral devices may include components such as speakers (not shown) and a printer 646 which can be connected to computer 602 via the input/output interfaces 640.

Computer 602 may operate in a networked environment using logical connections to one or more remote computers, such as a remote computing device 648. By way of example, the remote computing device 648 can be a personal computer, portable computer, a server, a router, a network computer, a peer device or other common network node, and the like. The remote computing device 648 is illustrated as a portable computer that may include many or all of the elements and features described herein relative to computer system 602.

Logical connections between computer 602 and the remote computer 648 are depicted as a local area network (LAN) 650 and a general wide area network (WAN) 652. Such networking environments are commonplace in offices, enterprise-wide computer networks, intranets, and the Internet. When implemented in a LAN networking environment, the computer 602 is connected to a local network 650 via a network interface or adapter 654. When implemented in a WAN networking environment, the computer 602 includes a modem 656 or other means for establishing communications over the wide network 652. The modem 656, which can be internal or external to computer 602, can be connected to the system bus 608 via the input/output interfaces 640 or other appropriate mechanisms. It is to be appreciated that the illustrated network connections are exemplary and that other means of establishing communication link(s) between the computers 602 and 648 can be employed.

In a networked environment, such as that illustrated with computing environment 600, program modules depicted relative to the computer 602, or portions thereof, may be stored in a remote memory storage device. By way of example, remote application programs 658 reside on a memory device of remote computer 648. For purposes of illustration, application programs and other executable program components, such as the operating system, are illustrated herein as discrete blocks, although it is recognized that such programs and components reside at various times in different storage components of the computer system 602, and are executed by the data processor(s) of the computer.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
retrieving a bug report filed on a beta program;
validating the bug report, the validating including identifying the beta program through a program ID and identifying a site type through a site type ID;
storing the bug report in database tables created based on the program ID;
running predefined tasks associated with the program ID and the site type ID against the stored bug report to modify the bug report; and
inserting the modified bug report in a specified destination database.

2. A method as recited in claim 1, wherein retrieving a bug report comprises:
scanning one or more directories for bug reports; and
retrieving one or more bug reports stored in the one or more directories.

3. A method as recited in claim 2, wherein the bug reports are selected from the group comprising:
bug reports filed by a single beta customer regarding a single beta program;
bug reports filed by a single beta customer regarding different beta programs;
bug reports filed by multiple beta customers regarding a single beta program; and
bug reports filed by multiple beta customers regarding different beta programs.

4. A method as recited in claim 1, wherein retrieving a bug report comprises:
retrieving a bug report cabinet (.cab) file;
creating a directory for the .cab file; and
moving the .cab file into the directory.

5. A method as recited in claim 1, wherein the bug report is a cabinet (.cab) file and the validating comprises:
decompressing the .cab file;
accessing a report XML file from the decompressed .cab file;
comparing the report XML file to an associated XML schema definition (XSD); and
if the report XML file matches the XSD, validating a format of the report XML in the bug report.

6. A method as recited in claim 5, further comprising, if the report XML file does not match the XSD:
logging an error;
discontinuing processing of the cab file; and
moving the .cab file to a faulty .cab file directory.

7. A method as recited in claim 5, wherein the comparing comprises:
determining the program ID; and
associating the XSD with the report XML file based on a namespace derived from the program ID.

8. A method as recited in claim 1, wherein the predefined tasks are additionally associated with one or more factors selected from the group comprising:
the specified destination database; and
an element within the bug report; and
wherein the running predefined tasks includes:
identifying the predefined tasks in the database tables; and
applying the predefined tasks to the bug report stored in the database tables.

9. A method as recited in claim 1, further comprising throttling the bug report to determine whether to accept or reject the bug report.

10. A method as recited in claim 9, wherein throttling comprises, for a given throttling value, determining whether the bug report exceeds a maximum number of bug reports allowed per a period of time.

11. A method as recited in claim 10, wherein the throttling value is a user ID (identification), the determining comprising:
comparing a number of bug reports for the user ID with the maximum number allowed;
accepting the bug report if the number of bug reports for the user ID does not exceed the maximum number allowed; and
rejecting the bug report if the number of bug reports for the user ID exceeds the maximum number allowed.

12. A method as recited in claim 10, wherein the throttling value is a field value pair, the determining comprising:
comparing a number of bug reports associated with a matching field value pair with the maximum number allowed;
accepting the bug report if the number of bug reports for the matching field value does not exceed the maximum number allowed; and
rejecting the bug report if the number of bug reports for the matching field value exceeds the maximum number allowed.

13. One or more processor-readable media having processor-executable instructions configured for:
retrieving multiple bug reports that have been filed on a plurality of different software programs;
for each bug report, identifying an associated software program for which the bug report was filed;
processing each bug report using stored procedures specifically predefined according to the software program associated with the bug report; and
inserting a processed bug report into a destination database that is predetermined according to the software program.

14. One or more processor-readable media as recited in claim 13 having further processor-executable instructions configured for accepting or rejecting each bug report based on a maximum number of bug reports allowed for the associated software program and a throttling variable, the throttling variable selected from the group comprising:
an identification of a user who submitted the bug report; and
a matching field value from within the bug report.

15. One or more processor-readable media as recited in claim 13 wherein the identifying comprises:
for each bug report, opening a cabinet (.cab) file;
accessing a report XML file from the opened cab file; and
identifying the software program from a software program ID in the report XML file.

16. One or more processor-readable media as recited in claim 15 wherein the identifying further comprises:
accessing a schema definition (XSD) associated with the software program ID;
comparing a schema of the report XML file with the XSD;
validating the bug report if the schema matches the XSD; and
discontinuing processing of the bug report if the schema does not match the XSD.

17. One or more processor-readable media as recited in claim 13, wherein the processing each bug report using stored procedures is selected from the group comprising:
modifying a bug report;
sending an email related to a bug report;
initiating an executable program related to a bug report;
logging an event related to a bug report; and
modifying a status element related to a bug report.

18. A beta parser system that is extensible to identify and parse various beta software programs, the system comprising:
multiple bug reports that have been filed for a plurality of different software programs; and
a beta parser configured to identify a software program associated with each bug report and to modify each bug report using a predefined set of procedures corresponding to the identified software program.

19. A system as recited in claim 18, wherein the beta parser comprises an executable beta parser module configured to retrieve the bug reports and to validate the contents of each bug report against a schema definition (XSD).

20. A system as recited in claim 19, wherein the beta parser further comprises an SQL database having tables for storing contents of each bug report and its corresponding set of procedures, and for applying the set of procedures against the contents of the bug report as directed by the beta parser module.
